(19) United States
(12) Patent Application Publication
(10) Pub. No.: US 2026/0043990 A1
(43) Pub. Date: Feb. 12, 2026

(54) DISPLAY OPTICAL SYSTEM AND DISPLAY APPARATUS

(71) Applicant: CANON KABUSHIKI KAISHA, Tokyo (JP)

(72) Inventor: Masakazu TOHARA, Tokyo (JP)

(21) Appl. No.: 19/232,945

(22) Filed: Jun. 10, 2025

(30) Foreign Application Priority Data
Aug. 7, 2024 (JP) 2024-130502

(51) Int. Cl. G02B 17/08; G02B 27/01

(52) U.S. Cl. CPC G02B 17/0856; G02B 27/0172

(57) ABSTRACT

A display optical system is configured to guide light from a display element to an observation side. The display optical system includes a first lens, a second lens adjacent to and disposed on a display element side of the first lens, and at least two transmissive reflective surfaces. When viewed from a direction in which an optical axis of the display optical system extends, each of the first lens and the second lens has a noncircular shape. In a case where a degree of a difference between the noncircular shape and a circular shape is called noncircularity, noncircularity of the first lens and noncircularity of the second lens are different from each other.

### BACKGROUND

### Field of the Technology

The present disclosure relates to a display optical system for a display apparatus such as a head-mounted display (HMD) configured to guide light from a display element to an observer's (or viewer's) eye.

### Description of the Related Art

As such a display optical system, Japanese PCT Domestic Publication No. 2018-512602 disclose optical systems that fold an optical path utilizing polarization to reduce the thickness and achieve a wider angle of view. In a case where a resin lens is used to reduce the weight of such a display optical system and the birefringence in the resin lens is large, a proper polarization state cannot be obtained, a light amount guided to the eye is reduced, and unnecessary light (ghosts) is generated. In a case where the lens is circular to reduce the birefringence in the resin lens, the lens may interfere with the observer's face (nose, forehead, etc.).

### SUMMARY

A display optical system according to one aspect of the present disclosure is configured to guide light from a display element to an observation side. The display optical system includes a first lens, a second lens adjacent to and disposed on a display element side of the first lens, and at least two transmissive reflective surfaces. When viewed from a direction in which an optical axis of the display optical system extends, each of the first lens and the second lens has a noncircular shape. In a case where a degree of a difference between the noncircular shape and a circular shape is called noncircularity, noncircularity of the first lens and noncircularity of the second lens are different from each other. A display apparatus having the above display optical system constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of a display apparatus according to Example 1.

FIG. 2 is a sectional view illustrating the configuration of a display optical system according to Example 1.

FIG. 3 is an external view of the display apparatus according to Example 1.

FIG. 4 is an optical path diagram of the display optical system according to Example 1.

FIG. 5 illustrates a first lens in Example 1.

FIG. 6 explains a second lens in Example 1.

FIG. 7 is a sectional view of a display apparatus according to Example 2.

FIG. 8 is a sectional view of a display optical system according to Example 2.

FIG. 9 is an optical path diagram of the display optical system according to Example 2.

FIG. 10 illustrates a first lens in Example 2.

FIG. 11 illustrates a second lens in Example 2.

FIG. 12 illustrates the first and second lenses cemented together in Example 2.

FIG. 13 is a sectional view of the display apparatus according to a variation of Example 2.

FIG. 14 illustrates the first and second lenses cemented together and a camera in Example 2.

FIG. 15 is a sectional view of a display apparatus according to Example 3.

FIG. 16 is a sectional view of a display optical system according to Example 3.

### DESCRIPTION OF THE EMBODIMENTS

Referring now to the accompanying drawings, a detailed description will be given of embodiments according to the disclosure.

### Example 1

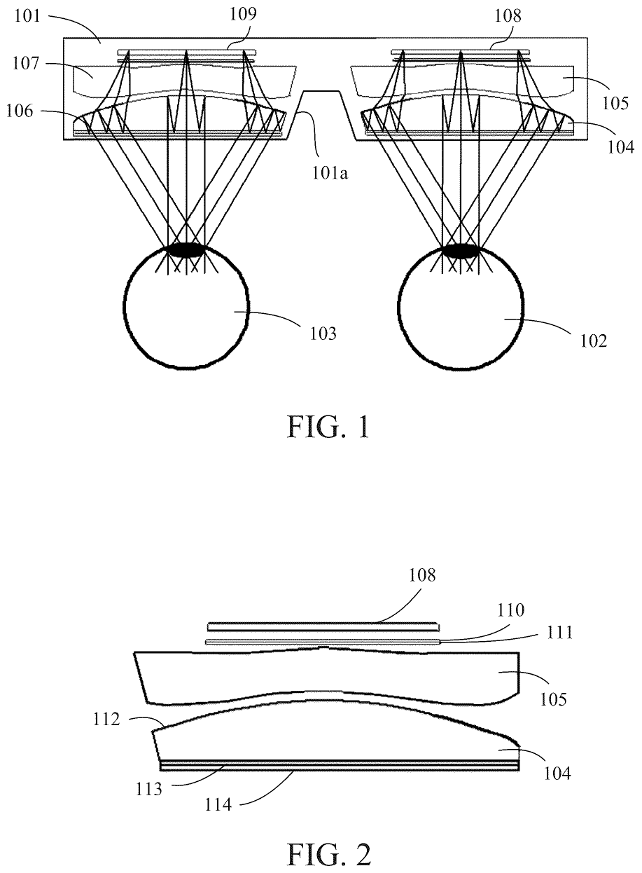

FIG. 3 illustrates the appearance of an HMD 101 as a display apparatus according to Example 1. FIG. 1 illustrates the configuration of the HMD 101. Reference numeral 102 denotes the right eye of an observer, and reference numeral 103 denotes the left eye of the observer.

The HMD 101 includes a right-eye optical system (104, 105) and a left-eye optical system (106, 107) as display optical systems, and a right-eye display element 108 and a left-eye display element 109. In the right-eye optical system and the left-eye optical system, the side where the eyes 102 and 103 are located will be called an observation side, and the side where the display elements 108 and 109 are located will be called a display element side. A direction in which the optical axes of the right-eye optical system and the left-eye optical system extend will be called an optical axis direction.

The right-eye optical system includes, in order from the observation side, a first lens 104 and a second lens 105 adjacent to and disposed on the display element side of the first lens 104. The left-eye optical system includes, in order from the observation side, a first lens 106 and a second lens 107 adjacent to and disposed on the display element side of the first lens 106. Each of the display elements 108 and 109 is an organic EL display, and unpolarized light is emitted from the organic EL display. The right-eye optical system and the left-eye optical system guide light from the right-eye display element 108 and the left-eye display element 109 to the right eye 102 and the left eye 103 of the observer, respectively, to allow the observer to observe an enlarged virtual image (display image) of an original image displayed on each display element.

In this example, each of the right-eye optical system and the left-eye optical system has a focal length of 12 mm, a horizontal display angle of view of 55°, a vertical display angle of view of 40°, and a diagonal display angle of view of 65°. A distance (eye relief) between the HMD 101 and the observer's eyes is 20 mm. In order for the observer to observe an image with a high immersion sense, the diagonal display angle of view may be 60° or more.

A distance on the optical axis from a surface of each of the first lenses 104 and 106 disposed on its observation side to a surface of each of the second lenses 105 and 107 disposed on its display element side is 12.5 mm, and thus the optical system can have a reduced thickness. The first lenses 104 and 106 and the second lenses 105 and 107 are adjacent to each other with an air gap. In order to reduce the thickness of each optical system, a distance on the optical axis from a surface of each of the first lenses 104 and 106 disposed on its observation side to a surface of each of the second lenses 105 and 107 disposed on its display element side may be 15 mm or less.

Each of the right-eye optical system and the left-eye optical system according to this example is an optical system that folds the optical path utilizing polarization. The optical path will be described with reference to FIGS. 1 and 2. FIG. 2 illustrates the detailed configuration of the right-eye optical system. Between the right-eye display element 108 and the second lens 105, a polarizing plate 110 and a phase plate 111 are arranged in this order from the display element side. A half-mirror 112 constituting a first transmissive reflective surface is vapor-deposited on the surface of the first lens 104 disposed on the side of the second lens 105. On the observation side of the first lens 104, a phase plate 113 and a polarization separation surface (hereinafter referred to as PBS) 114 as a second transmissive reflective surface provided with a polarization separation element are arranged in this order from the display element side. Both the phase plate 113 and the PBS 114 have a planar shape.

Both the phase plate 111 and the phase plate 113 are quarter waveplates that give a phase difference (retardation) of λ/4 to light that transmits through them. The slow axis of the phase plate 111 is tilted by 45° relative to the polarization direction of the linearly polarized light that transmits through the polarizing plate 110, and the slow axis of the phase plate 113 is tilted by −45° relative to the polarization direction of the linearly polarized light that transmits through the polarizing plate 110. The polarization direction of the linearly polarized light that transmits through the polarizing plate 110 and the polarization direction of the linearly polarized light that transmits through the PBS 114 are orthogonal to each other.

Of the unpolarized light emitted from the right-eye display element 108, the linearly polarized light that transmits through the polarizing plate 110 transmits through the phase plate 111 and is converted into circularly polarized light. This circularly polarized light transmits through the half-mirror 112 and then transmits through the phase plate 113 and is converted into linearly polarized light. Since the polarization direction of this linearly polarized light is orthogonal to the polarization direction that transmits through the PBS 114, it is reflected by the PBS 114, transmits through the phase plate 113, and is converted into circularly polarized light. The circularly polarized light is reflected by the half-mirror 112, transmits through the phase plate 113, and is converted into linearly polarized light. Since the polarization direction of this linearly polarized light matches the polarization direction of light that transmits through the PBS 114, it transmits through the PBS 114 and is guided to the right eye 102. The configuration and optical path of the left-eye optical system are similar to those of the right-eye optical system.

Folding the optical path utilizing polarization as described above can provide a display optical system with a reduced thickness, a short focal length, and a wide angle of view.

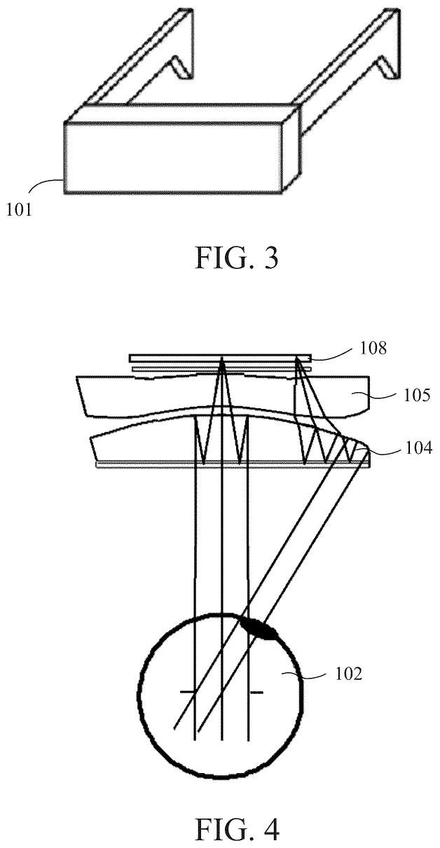

The exit pupil in the display optical system is located at 30 mm, which is the sum of the eyeball rotation radius of 10 mm and the eyeball eye relief of 20 mm, as illustrated in FIG. 4, and an exit pupil diameter is set to 6 mm. By doing so, even when the eyeball rotates to observe up, down, left, or right, light in the rotating direction is incident on the eyeball. Since the HMD is worn on the observer's head (in front of the face), and the eye relief may be 15 mm or more so that observers wearing glasses can wear it. In a case where the eye relief is too long, the outer shape of the lens becomes large and the size of the HMD increases, so the eye relief may be 25 mm or less.

The HMD to be worn on the head may be lightweight. Thus, the lenses constituting the display optical system may be lenses (resin lenses) made of a resin material with a smaller specific gravity than that of glass. In this example, the first lenses 104 and 106 and the second lenses 105 and 107 are resin lenses, and the first lenses 104 and 106 are made of plano-convex aspherical lenses to enhance the aberration correcting effect. Both sides of the second lenses 105 and 107 are aspherical.

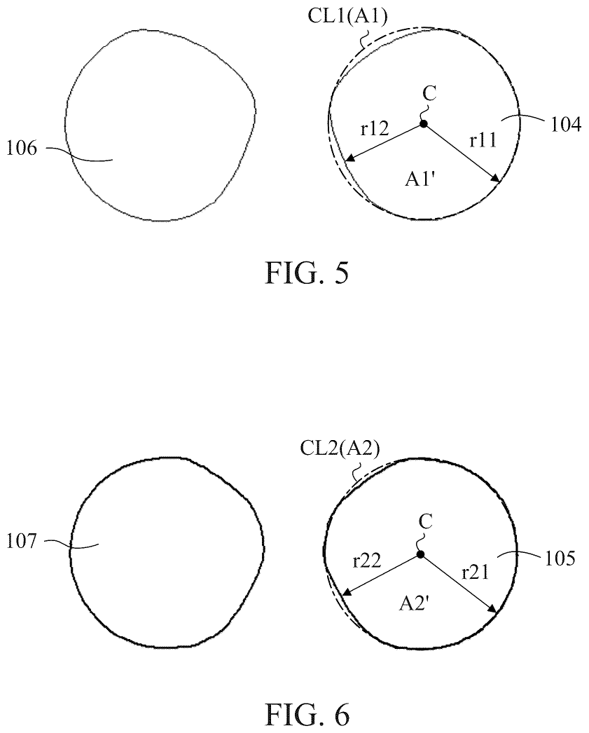

The HMD 101 has a nose escape (or relief) portion 101a and a forehead escape portion illustrated in FIG. 1 so that the HMD 101 does not interfere with parts of the face (nose or forehead escape) in a case where the observer wears the HMD 101 on his head. Thus, as illustrated in FIGS. 5 and 6, the first lenses 104 and 106 and the second lenses 105 and 107 are not circular when viewed from the optical axis direction, but are formed in a noncircular shape with an outer shape on the nose side and the forehead escape side being smaller.

However, resin lenses as molded products (particularly lenses using thermoplastic resin) tend to have birefringence caused by residual stress during molding. In a case where a lens with birefringence is used, a phase difference is given to the light that transmits through it, and the proper polarization state of the light cannot be maintained. As a result, unnecessary light (ghost light) is generated without being reflected by the PBS 114 but is guided directly to the viewer's eye, rather than the normal optical path illustrated in FIG. 1. An unnecessary phase difference is imparted to the light on the normal optical path after reflection by the PBS 114, and ultimately part of the light that is to transmit through the PBS 114 is reflected, which may reduce a light amount in a displayed image. Originally, the shape of each lens when viewed from the optical axis direction may be circular. A circular lens shrinks isotropically during molding, and birefringence inside the lens can be reduced. However, as described above, each lens is to be formed into a noncircular shape.

Accordingly, in this example, each lens is formed into a noncircular shape while the birefringence that occurs during molding of the lens is reduced. More specifically, as illustrated in FIGS. 5 and 6, each of the first lens (104, 106) and the second lens (105, 107) is noncircular by making the nose-side and forehead escape-side portions (part of the outer circumference edge of each lens: referred to as a non-arc portion hereinafter) closer to a straight line than another arc-shaped portion (referred to as an arc portion hereinafter).

Here, a degree of difference (deviation) between a noncircular shape and a circular shape will be referred to as noncircularity. In this example, the noncircularity of the first lens and the noncircularity of the second lens are different from each other. More specifically, the noncircularity of the second lens is smaller than the noncircularity of the first lens.

In this example, as illustrated in FIGS. 1 and 2, the end face of the noncircular lens on its nose escape side is formed obliquely relative to the optical axis. The first and second lenses are directly molded as noncircular lenses, rather than cutting the nose-side and forehead escape-side portions of a circular lens. Thereby, each lens can be easily manufactured (by eliminating the cutting process).

As illustrated in FIGS. 5 and 6, the noncircular shapes of the first lens (104, 106) and the second lens (105, 107) can be shapes in which a distance from optical axis C (centers of circles CL1 and CL2 described later) to part of the outer circumference edges of the lenses is shorter than a distance from the optical axis C to another part. In this example, a distance r11 from the optical axis to an arc portion of the first lens (a maximum distance from the optical axis to the outer circumference edge, which is a radius of the circle CL1 in which the first lens is inscribed) is 20 mm, and a minimum distance r12 from the optical axis to the noncircular portion is 15 mm. In a case where the noncircularity is defined as a ratio of a difference between the maximum and minimum values of the above distances to the maximum value, it is 5/20=0.25.

On the other hand, a distance r21 from the optical axis to the arc portion of the second lens (a maximum distance from the optical axis to the outer circumference edge, which is a radius of the circle CL2 inscribed in the second lens) is 20 mm, and a minimum distance r22 from the optical axis to the non-arc portion is 17.5 mm. In a case where the noncircularity is defined as the ratio described above, it becomes 2.5/20=0.13. Thus, the noncircularity of the second lens is smaller than the noncircularity of the first lens. In other words, the shape of the second lens is closer to a circle than the shape of the first lens.

The noncircularity of the first lens as defined above may be 0.2 or more and 0.3 or less. In a case where the noncircularity is less than 0.2, an escape amount of the nose escape portion 101a and the forehead escape portion becomes too small, and it causes the HMD 101 to interfere with the nose or forehead escape of the observer. In a case where the noncircularity is greater than 0.3, the birefringence of the first lens increases, and ghost light may be generated and the light amount may be significantly reduced.

The noncircularity of the second lens as defined above may be greater than or equal to 0.1 and less than 0.2. In a case where the noncircularity is less than 0.1, the escape amount at the nose escape portion and forehead escape portion will be too small, which will cause the HMD 101 to interfere with the observer's nose or forehead escape. In a case where the noncircularity is 0.2 or more, the birefringence of the second lens increases, and ghost light may be generated and the light amount may be significantly reduced.

In a display optical system utilizing polarization as in this example, the resin material of the first lens may have a low refractive index and low dispersion, and the resin material of the second lens may have a higher refractive index and higher dispersion than those of the first lens, from the viewpoint of aberration correction. However, due to large birefringence of the material mixed with the resin material to increase the refractive index, resin materials with a high refractive index tend to have large birefringence. Table 1 summarizes the refractive index for the d-line, Abbe number based on the d-line, and photoelastic coefficient of the resin materials of the first lens 104 (106) and the second lens 105 (107) in this example.

TABLE 1

| | REFRACTIVE | ABBE | PHOTOELASTIC |
|---|---|---|---|
| | INDEX | NUMBER | COEFFICIENT [10⁻¹²/Pa] |
| LENS 104 | 1.54 | 56 | 8 |
| LENS 105 | 1.64 | 22 | 48 |

It may be understood from Table 1, the refractive index of the second lens 105 is larger than that of the first lens 104, so the birefringence of the second lens 105 is larger than that of the first lens 104. More specifically, the photoelastic constant of the first lens 104 is 8×10⁻¹² [1/Pa] and that of the second lens 105 is 48×10⁻¹² [1/Pa], so that the second lens 105 has a larger photoelastic constant.

To reduce the birefringence of the noncircular lenses, the photoelastic constant of the first lens 104 may be 10×10⁻¹² [1/Pa] or less, and the photoelastic constant of the second lens 105 may be 50×10⁻¹² [1/Pa] or less.

To reduce the birefringence of the display optical system, the second lens 105, which is made of a resin material with large birefringence, may have a shape with a small noncircularity. Thus, the noncircularity of the second lens 105 is smaller than that of the first lens 104.

By doing this, the first lens and the second lens can be noncircular so that the HMD 101 does not interfere with the observer's nose or forehead escape, while the birefringence that occurs during molding of each lens can be kept small.

In a case where the shape of the observer's face is considered, the escape amount at the nose escape portion and forehead escape portion can be small as a distance from the eyes increases. Therefore, even if the noncircularity of the second lens is smaller than that of the first lens to reduce the escape amount, the HMD 101 does not interfere with the observer's face.

As illustrated in FIGS. 5 and 6, the noncircular shapes of the first lens (104, 106) and the second lens (105, 107) can be shapes in which part of the outer circumference edges of these lenses is closer to the optical axis than the circles CL1 and CL2 in which the lenses are inscribed. In this case, the noncircularity can be defined as a ratio of the difference between the areas A1′ and A2′ of the first lens and the second lens, respectively, and the areas A1 and A2 of the circles CL1 and CL2 to the areas A1 and A2 of the circles CL1 and CL2. In this case, the noncircularity of the first lens in this example is 0.07, and the noncircularity of the second lens is 0.03, and the noncircularity of the second lens is smaller than the noncircularity of the first lens.

As described above, the noncircularity of the first lens, when it is defined as a ratio of area, may be 0.06 or more and 0.10 or less. In a case where the noncircularity of the first lens is less than 0.06, the escape amount is too small, and the HMD 101 may interfere with the observer's face. In a case where the noncircularity of the first lens is greater than 0.10, the birefringence of the first lens increases, ghost light may be generated, and a light amount may be reduced significantly.

The noncircularity of the second lens, when it is defined as a ratio of area, may be 0.01 or more and less than 0.06. In a case where the noncircularity of the second lens is less than 0.01, the escape amount reduces, and the HMD 101 may interfere with the observer's face. In a case where the noncircularity of the second lens is 0.06 or more, the birefringence of the second lens increases, ghost light may be generated, and a light amount may be reduced significantly.

The noncircularity may be defined as a ratio of the volume reduced from a circular lens (a lens whose entire outer circumference edge is inscribed in each of the circles CL1 and CL2) that is the base of the first lens (104, 106) and the second lens (105, 107) for the noncircular lens to the volume of the circular lens. In this example, the noncircularity of the first lens is 0.04, and the noncircularity of the second lens is 0.01, and the noncircularity of the second lens is smaller than that of the first lens.

As described above, the noncircularity of the first lens in a case where the noncircularity is defined as the volume ratio may be 0.03 or more and 0.05 or less. In a case where the noncircularity is less than 0.03, an escape amount becomes too small and the HMD 101 may interfere with the observer's face. In a case where the noncircularity is greater than 0.05, the birefringence of the first lens increases, ghost light may occur and the light amount may be reduced.

The noncircularity of the second lens in a case where the noncircularity is defined as the volume ratio may be 0.005 or more and less than 0.03. In a case where the noncircularity is less than 0.005, the escape amount becomes too small and the HMD 101 interferes with the observer's face. In a case where the noncircularity is 0.03 or more, the birefringence of the second lens becomes large, ghost light may be generated, and the light amount may be significantly reduced.

The noncircularity may be defined using a factor other than the distance from the optical axis, area, and volume described above. Depending on the definition, the noncircularity of the second lens may be greater than the noncircularity of the first lens, but the shape of the second lens may be closer to a circle than the first lens.

In the display optical system according to this example, the surface on which the half-mirror 112 is vapor-deposited may have a convex shape toward the display element side. Vapor-depositing the half-mirror 112 on this convex lens surface can reduce the thickness of the display optical system while achieving a wider angle of view. The convex lens surface on which the half-mirror 112 is vapor-deposited as an aspheric shape can improve the aberration correcting effect.

In order to reduce ghost light and increase the contrast of the displayed image, a polarizing plate may be placed on the observation side of the PBS 114 (between the PBS 114 and the exit pupil where the viewer's eye is located).

The surface of the first lens (104, 106) disposed on its observation side on which the phase plate 113 and the PBS 114 are provided may be flat. Thereby, the thickness of the display optical system can be reduced and a sufficiently long eye relief can be secured. In a case where this surface is concave toward the observation side, the thickness of the first lens increases in order to secure the eye relief around the first lens. In a case where this surface is convex toward the observation side, the thickness of the first lens increases in order to secure the thickness of the edge portion of the first lens. In this example, as described above, a plano-convex lens with a flat surface on the observation side is used as the first lens.

In this example, a phase difference imparted to the light by the phase plates 111 and 113 is λ4, but the phase difference imparted may be shifted from λ/4 so that the birefringence of the first and second lenses can be cancelled by the phase plate. The sum of the phase differences of the first lens and the phase plate 113 may be 3λ/20 or more and 7λ/20 or less. The sum of the phase differences of the second lens and the phase plate 111 may be 3λ/20 or more and 7λ/20 or less. In a case where the sum of the phase differences is outside these ranges, the intensity of ghost light increases and natural image cannot be observed.

This example uses an organic EL display that emits unpolarized light as the display element, but may use a liquid crystal display that emits linearly polarized light as the display element. In this case, the polarizing plate 110 on the display element side is not necessary, and the thickness of the display optical system can be further reduced.

This example uses the PBS 114 as the second transmissive reflective surface, which transmits or reflects linearly polarized light according to the polarization direction of the linearly polarized light, but may use a polarization separation element that transmits or reflects circularly polarized light according to the direction of the circularly polarized light. In this case, the phase plate 113 is not necessary, and the thickness of the display optical system can be reduced.

In this example, the half-mirror 112 is disposed between the first lens and the second lens as the first transmissive reflective surface, and the PBS 114 is disposed on the observation side relative to the first lens, but another arrangement may be used. For example, a curved PBS may be disposed between the first lens and the second lens, and the half-mirror may be disposed on the observation side relative to the first lens.

The configuration (noncircularity and another configuration), the condition that may be satisfied, and the alternative configuration described above are similarly applicable to the other examples described below.

### Example 2

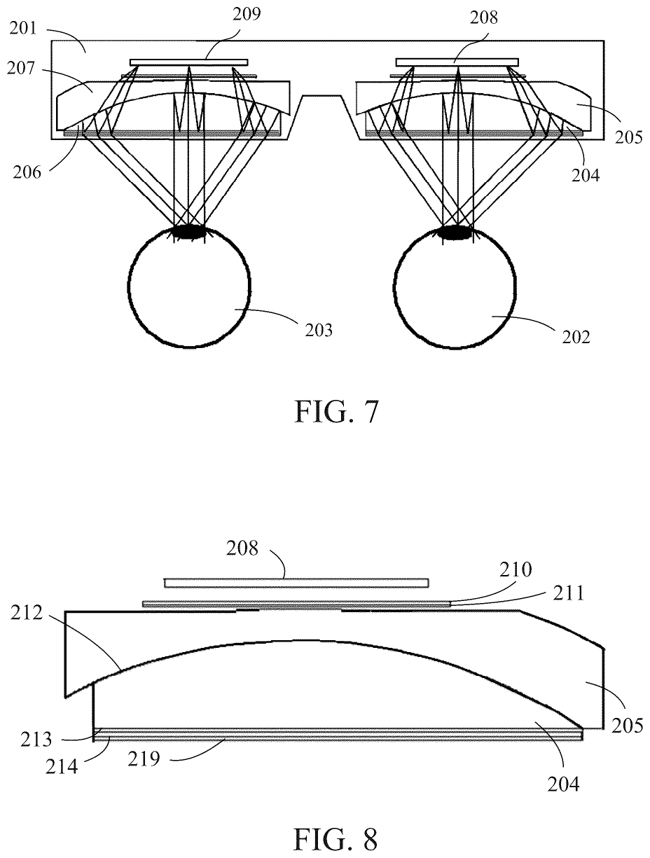

FIG. 7 illustrates the configuration of an HMD 201 according to Example 2. Reference numeral 202 denotes the right eye of the observer, and reference numeral 203 denotes the left eye of the observer.

The HMD 201 includes a right-eye optical system (204, 205) and a left-eye optical system (206, 207) as display optical systems, a right-eye display element 208, and a left-eye display element 209. The right-eye optical system includes, in order from the observation side, a first lens 204 and a second lens 205 adjacent to (cemented to) and disposed on the display element side of the first lens 204. The left-eye optical system includes, in order from the observation side, a first lens 206 and a second lens 207 adjacent to (cemented to) the first lens 206 disposed on its display element side. Each of the display elements 208 and 209 is an organic EL display.

The right-eye optical system and the left-eye optical system guide light from the right-eye display element 208 and the left-eye display element 209 to the right eye 202 and the left eye 203 of the observer, respectively, to allow the observer to observe an enlarged virtual image (display image) of the original image displayed on each display element.

In this example, each of the right-eye optical system and the left-eye optical system has a focal length of 13 mm, a horizontal display angle of view of 60°, a vertical display angle of view of 60°, and a diagonal display angle of view of 78°. An eye relief is 18 mm. In order for the observer to observe an image with a high immersion sense, the diagonal display angle of view may be 75° or more.

A distance on the optical axis from a surface of each of the first lenses 204 and 206 disposed on its observation side to a surface of each of the second lenses 205 and 207 disposed on its display element side is 13.5 mm, and thus the optical system can have a reduced thickness.

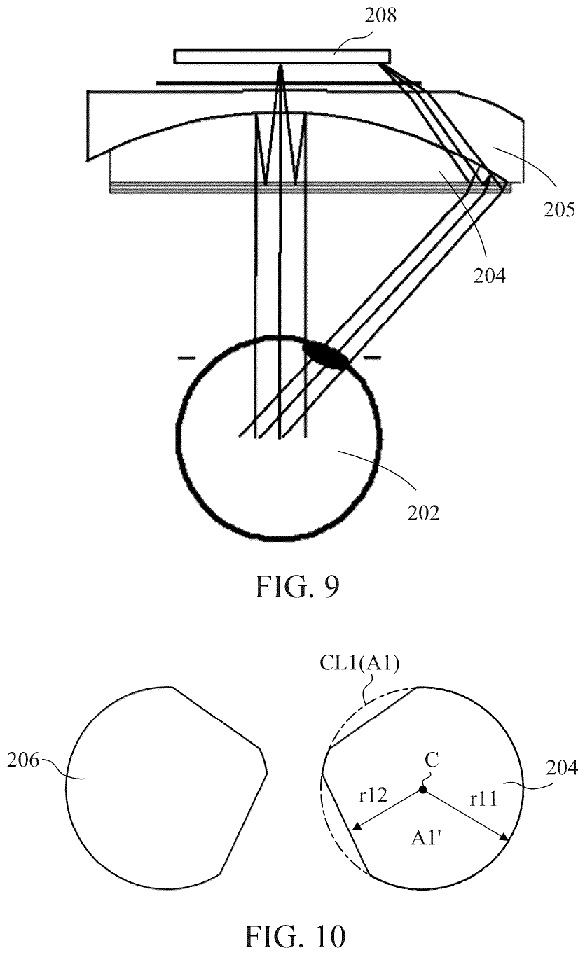

The exit pupil in each optical system is located at 28 mm, which is the sum of the eyeball rotation radius of 10 mm and the eye relief of 18 mm, as illustrated in FIG. 9, and an exit pupil diameter is 6 mm.

Each of the right-eye optical system and the left-eye optical system according to this example is an optical system that folds the optical path utilizing polarization, as in Example 1. FIG. 8 illustrates the detailed configuration of the right-eye optical system. As in Example 1, a polarizing plate 210 and a phase plate 211 are arranged in this order from the display element side between the right-eye display element 208 and the second lens 205. A half-mirror 212 that constitutes the first transmissive reflective surface is vapor-deposited on the surface of the first lens 204 facing the second lens 205. On the observation side of the first lens 204, a phase plate 213 and a PBS 214 as a second transmissive reflective surface are arranged in this order from the display element side. Both the phase plate 213 and the PBS 214 have a planar shape.

Both the phase plate 211 and the phase plate 213 are quarter waveplates. The slow axis of the phase plate 211 is tilted by 45° relative to the polarization direction of the linearly polarized light that transmits through the polarizing plate 210, and the slow axis of the phase plate 213 is tilted by −45° relative to the polarization direction of the linearly polarized light that transmits through the polarizing plate 210. The polarization direction of the linearly polarized light that transmits through the polarizing plate 210 and the polarization direction of the linearly polarized light that transmits through PBS 214 are orthogonal to each other.

Of the unpolarized light emitted from the right-eye display element 208, the linearly polarized light that transmits through the polarizing plate 210 transmits through the phase plate 211 and is converted into circularly polarized light. The circularly polarized light transmits through half-mirror 212 and then transmits through phase plate 213 and is converted into linearly polarized light. Since the polarization direction of this linearly polarized light is orthogonal to the polarization direction of the light that transmits through the PBS 214, it is reflected by the PBS 214, transmits through phase plate 213, and is converted into circularly polarized light. The circularly polarized light is reflected by the half-mirror 212, transmits through the phase plate 213, and is converted into linearly polarized light. This linearly polarized light transmits through the PBS 214 and is guided to the right eye 202 because its polarization direction coincides with the polarization direction of the light that transmits through the PBS 214. In this example, a polarizing plate 219 is disposed on the observation side relative to the PBS 214 to reduce ghost light and increase the contrast of the displayed image. The configuration and optical path of the left-eye optical system are similar to those of the right-eye optical system.

Folding the optical path utilizing polarization as described above can provide a display optical system with a reduced thickness, a short focal length, and a wide angle of view.

As in Example 1, the first lenses 204 and 205 and the second lenses 206 and 207 in this example are made of resin lenses to reduce weight, and aspherical lenses to enhance the aberration correcting effect. In this example, the first lens and the second lens are cemented together to form a cemented lens. By forming the first lens and the second lens as a cemented lens, the first lens and the second lens can be easily held. By forming the first lens and the second lens as a cemented lens, the surface on which the half-mirror 212 is deposited may be a surface of the second lens disposed on its observation side, and even in this case, the surface on which the half-mirror 212 is deposited is a surface having a convex shape toward the display element side.

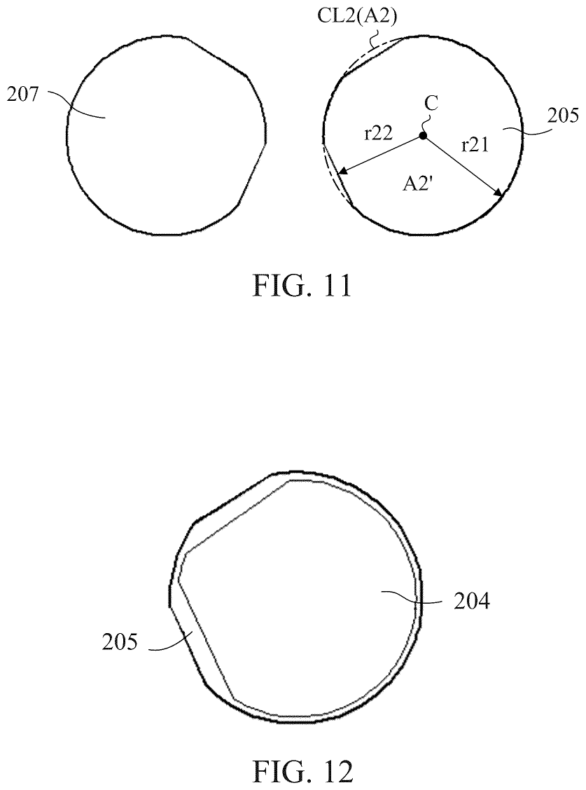

The HMD 201 according to this example also has a nose escape portion and a forehead escape portion so as not to interfere with the nose or forehead escape of the observer when the HMD 201 is worn on the observer's head, and the first lenses 204 and 205 and the second lenses 206 and 207 are also formed as noncircular lenses as illustrated in FIGS. 10 and 11. More specifically, each of the first lens and the second lens is noncircular by making the noncircular portions of the nose side and the forehead escape side of the first lens and the second lens closer to a straight line shape than the other arc portions. Also in this example, the noncircularity of the first lens and the noncircularity of the second lens are different from each other. More specifically, the noncircularity of the second lens is smaller than the noncircularity of the first lens. As a result, a step occurs when the first lens and the second lens are cemented. In this example, as illustrated in FIGS. 7 and 8, the end face of the noncircular lens on the nose escape side is formed parallel to the optical axis.

In this example, a distance r11 from the optical axis to the arc portion of the first lens (the radius of the circle CL1 inscribed in the first lens) is 21 mm, and a minimum value r12 of the distance from the optical axis to the noncircular portion is 15 mm. In a case where the noncircularity is defined as a ratio of a difference between the maximum and minimum values of the above distances to the maximum value, then it is 6/21=0.29.

On the other hand, a distance r21 from the optical axis to the arc portion of the second lens (the radius of the circle CL2 inscribed in the second lens) is 22 mm, and a minimum value r22 of the distance from the optical axis to the noncircular portion is 18 mm. In a case where the noncircularity is defined as the above ratio, then it is 4/22=0.18. Thus, the noncircularity of the second lens is smaller than the noncircularity of the first lens. In other words, the shape of the second lens is closer to a circle than the first lens.

Also in this example, as in Example 1, a refractive index of the second lens is larger than that of the first lens, so the birefringence of the second lens is larger than that of the first lens. More specifically, a photoelastic constant of the first lens is 5×10⁻¹² [1/Pa], and a photoelastic constant of the second lens is 35×10⁻¹² [1/Pa], which is larger for the second lens. In order to reduce the birefringence of the display optical system, the second lens, which is made of a resin material with large birefringence, may have a shape with a small noncircularity. Thus, the noncircularity of the second lens is smaller than that of the first lens.

By doing this, the first lens and the second lens can be noncircular so that the HMD 201 does not interfere with the nose or forehead of the observer, while the birefringence that occurs during molding of each lens can be reduced.

The noncircularity may be defined as a ratio of a difference between the areas A1′ and A2′ of the first lens (204, 206) and the second lens (205, 207) when viewed from the optical axis direction and the areas A1 and A2 of the circles CL1 and CL2 to the areas A1 and A2 of the circles CL1 and CL2. In this case, the noncircularity of the first lens in this example is 0.09, and the noncircularity of the second lens is 0.05, so the noncircularity of the second lens is smaller than the noncircularity of the first lens.

The noncircularity may be defined as a ratio of the volume reduced from a circular lens (a lens whose entire outer circumference edge is inscribed in each of the circles CL1 and CL2) that is the base of the first lens and the second lens for the noncircular lens to the volume of the circular lens. In this example, the noncircularity of the first lens is 0.05, and the noncircularity of the second lens is 0.02, and the noncircularity of the second lens is smaller than the noncircularity of the first lens.

In this example, the first lens (204, 206) and the second lens (205, 207) are cemented (bonded) together with an adhesive. At this time, the outer shape of the second lens is larger than that of the first lens as illustrated in FIG. 12, and the surface of the second lens facing the first lens is concave as illustrated in FIG. 8. Therefore, the area of the concave surface outside the first lens becomes an adhesive pool, which prevents excess adhesive from adhering to each lens surface. In order to align the first lens and the second lens with each other during bonding them together, the non-arc portions of the first lens and the second lens may be linear in shape.

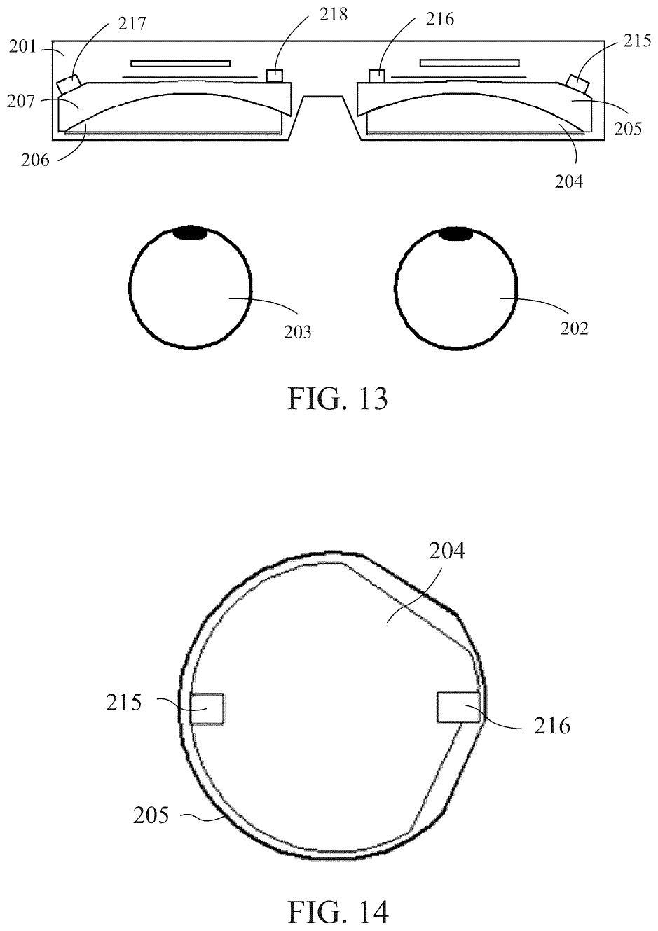

As illustrated in FIG. 13, the HMD 201 may include a right-eye infrared light source 215, a left-eye infrared light source 217, a right-eye infrared camera 216, and a left-eye infrared camera 218 to detect the observer's line of sight (visual line). The infrared light emitted from the right-eye infrared light source 215 transmits through the first lens 204 and the second lens 205 and is irradiated onto the observer's right eye (eyeball) 202, and the right-eye infrared camera 216 images the right eye 202 illuminated with the infrared light through the first lens 204 and the second lens 205. Similarly, the infrared light emitted from the left-eye infrared light source 217 transmits through the first lens 206 and the second lens 207 and is irradiated onto the observer's left eye (eyeball) 203, and the left-eye infrared camera 218 images the left eye 203 illuminated with the infrared light through the first lens 206 and the second lens 207.

In this case, as illustrated in FIG. 14, by placing the right-eye infrared camera 216 on the nose side of the observer, the robustness of line-of-sight detection is improved when the right eye moves up, down, left, or right. This is similarly applicable to the left-eye infrared camera 218. However, in a case where the non-arc portions of both the first lens and the second lens are large, it becomes difficult to place the infrared camera so that it does not extend beyond the non-arc portions toward the nose. Even if a plurality of infrared light sources are disposed, they cannot be disposed at the non-arc portions, and the line-of-sight detection accuracy decreases.

Thus, making the noncircularity of the second lens smaller than that of the first lens and making the outer shape of the second lens closer to a circle can place the infrared camera and the infrared light source at proper positions. As a result, the line-of-sight detection accuracy can be improved.

As described above, also in this example, the first lens (204, 206) and the second lens (205, 207) are resin lenses, and in a case where a temperature distribution occurs within each lens due to a rise in the temperature of the HMD 201, birefringence increases. In particular, noncircular lenses do not expand isotropically, so birefringence is likely to increase significantly. As described above, the second lens is formed from a resin material in which the birefringence of the second lens is greater than that of the first lens, but since the second lens is close to the display element, which is a heat source, and the temperature of the second lens is likely to rise, the birefringence is likely to increase even more.

In order to reduce the temperature distribution within each lens, the cemented lens may be held by a holding member that can transmit heat, such as a lens barrel. At this time, by holding the second lens using the holding member and adhesive or the like, the temperature distribution within the second lens can be kept small. In order to hold the second lens using the holding member, the outer shape of the second lens may be larger than the outer shape of the first lens.

As mentioned above, the surface on which the half-mirror 212 is deposited is a convex surface facing the display element. Depositing the half-mirror on this convex surface can reduce the thickness of the display optical system while achieving a wider angle of view. The convex aspheric surface on which the half-mirror 212 is deposited can improve the aberration correcting effect.

In a case where the half-mirror 212 is deposited on the surface of the second lens and the deposition area of the half-mirror 212 is larger than the outer shape of the first lens, the deposition surface may be exposed, ghost light may be generated, and deterioration may occur due to oxidation of the deposition surface. Thus, the deposition area of the half-mirror 212 may be smaller than the outer shape of the first lens.

### Example 3

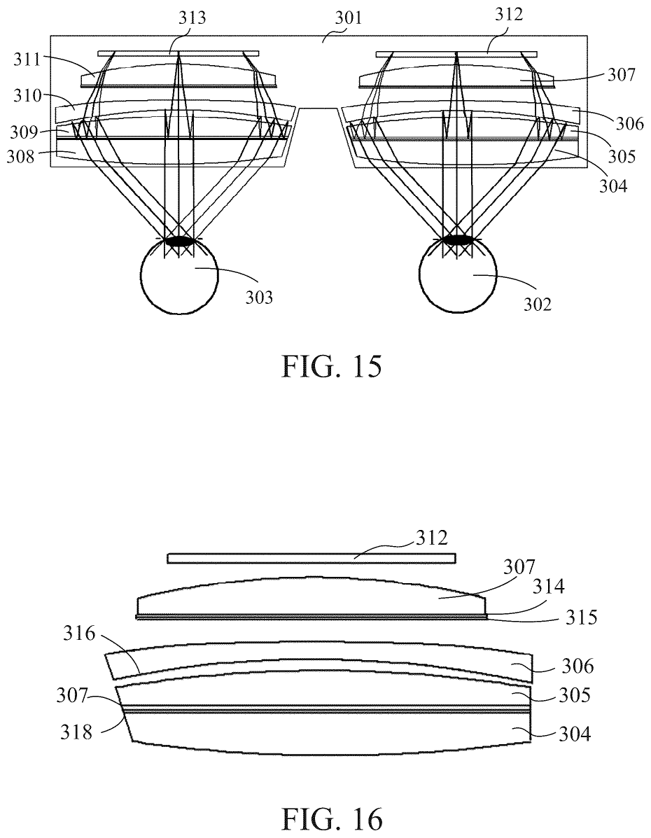

FIG. 15 illustrates the configuration of an HMD 301 according to Example 3. Reference numeral 302 denotes the observer's right eye, and reference numeral 303 denotes the observer's left eye.

The HMD 301 includes a right-eye optical system (304-307) and a left-eye optical system (308-311) as display optical systems, a right-eye display element 312, and a left-eye display element 313. The right-eye optical system includes, in order from the observation side, a lens 304, a first lens 305, a second lens 306 adjacent to and disposed on the display element side of the first lens 305, and a lens 306. The left-eye optical system includes, in order from the observation side, a lens 308, a first lens 309, a second lens 310 adjacent to and disposed on the display element side of the first lens 309, and a lens 311. Each of the display elements 312 and 313 is an organic EL display.

The right-eye optical system and the left-eye optical system guide light from the right-eye display element 312 and the left-eye display element 313 to the observer's right eye 302 and left eye 303, respectively, to allow the observer to observe an enlarged virtual image (display image) of the original image displayed on each display element.

In this example, each of the right-eye optical system and the left-eye optical system has a focal length of 11 mm, a horizontal display angle of view of 70°, a vertical display angle of view of 60°, and a diagonal display angle of view of 84°. An eye relief is 15 mm. A distance on the optical axis from the surface of each of the lenses 304 and 308 disposed on its observation side to a surface of each of the lenses 307 and 311 disposed on its display element side is 20 mm, and thus the optical system can have a reduced thickness. The first lenses 305 and 309 and the second lenses 306 and 310 are adjacent to each other via an air gap. A distance on the optical axis from a surface of each of the first lenses 305 and 309 disposed on its observation side to a surface of each of the second lenses 306 and 310 disposed on its display element side is 15 mm.

The exit pupil in each optical system is located at 25 mm, which is the eye relief of 15 mm plus the rotation radius of the eyeball of 10 mm, and an exit pupil diameter is 6 mm.

Each of the right-eye optical system and left-eye optical system according to this example is an optical system that folds the optical path utilizing polarization, as in Example 1. FIG. 16 illustrates the detailed configuration of the right-eye optical system. A polarizing plate 314 and a phase plate 315 are arranged in this order from the display element side between the lens 307 and the second lens 306. A half-mirror 316 that constitutes the first transmissive and reflective surface is vapor-deposited on the surface of the second lens 306 facing the first lens 305.

A phase plate 317 and a PBS 318 as a second transmissive reflective surface are arranged in this order from the display element side between the first lens 305 and the lens 304. Both the quarter waveplate 317 and the PBS 318 have a planar shape.

Both the phase plate 315 and the phase plate 317 are quarter waveplates. The slow axis of the phase plate 315 is tilted by 45° relative to the polarization direction of the linearly polarized light that transmits through the polarizing plate 314, and the slow axis of the phase plate 317 is tilted by −45° relative to the polarization direction of the linearly polarized light that transmits through the polarizing plate 314. The polarization direction of the linearly polarized light that transmits through the polarizing plate 314 and the polarization direction of the linearly polarized light that transmits through the PBS 318 are orthogonal to each other.

The unpolarized light emitted from the right-eye display element 312 transmits through the lens 307, transmits through the polarizing plate 314 to become linearly polarized light, transmits through the phase plate 315, and is converted into circularly polarized light. The circularly polarized light transmits through the second lens 306, the half-mirror 316, and the first lens 305, transmits through the phase plate 317, and is converted into linearly polarized light. This linearly polarized light is reflected by the PBS 318 because its polarization direction is orthogonal to the polarization direction of the light that transmits through the PBS 318, transmits through the phase plate 317, and is converted into circularly polarized light. The circularly polarized light transmits through the first lens 305, is reflected by the half-mirror 316, transmits through the first lens 305, transmits through the phase plate 317, and is converted into linearly polarized light. This linearly polarized light transmits through the PBS 318 because its polarization direction coincides with the polarization direction of the light that transmits through the PBS 318, and is guided to the right eye 302. The configuration and optical path of the left-eye optical system are similarly applicable to those of the right-eye optical system.

Folding the optical path utilizing polarization as described above can provide a display optical system with a reduced thickness, a short focal length, and a wide angle of view.

Similarly to Example 1, the lenses 304 to 311 in this example are made of resin lenses to reduce weight, and aspherical lenses to enhance the aberration correcting effect.

The HMD 301 according to this example also has a nose escape portion and a forehead escape portion so that the HMD 301 does not interfere with the observer's nose or forehead when worn on the head, and the lenses 304, 305, 306, 308, 309, and 310 are formed as noncircular lenses. More specifically, the noncircular portions of the lenses 304, 305, 306, 308, 309, and 310 on the nose-side and forehead-side escape portions are made closer to a straight line than the other circular portions to make them noncircular. As illustrated in FIGS. 15 and 16, the end faces of the noncircular lenses on the nose escape portion side are formed obliquely to the optical axis.

The lenses 307 and 311 closest to the display element are circular lenses because their outer shapes are small and do not affect the nose escape portion and the forehead escape portion. In this example as well, the noncircularity of the first lens (305, 309) and the noncircularity of the second lens (306, 310) are different from each other. More specifically, the noncircularity of the second lens is smaller than that of the first lens. The lenses (304, 308) closest to the observation position have the largest noncircularity in order to increase the escape amounts at the nose escape portion and forehead escape portion.

In this example, the birefringence of the first lens and the second lens arranged between the polarizing plate (314) and the PBS (318) may be reduced. A distance from the optical axis to the arc portion of the first lens (a radius of the circle inscribed in the first lens) is 23 mm, and a minimum value of a distance from the optical axis to the non-arc portion is 18 mm. In a case where the noncircularity is defined as a ratio of a difference between the maximum and minimum values of the above distance to the maximum value, it is 5/23=0.22.

On the other hand, a distance from the optical axis to the arc portion of the second lens (the radius of the circle inscribed in the second lens) is 24 mm, and a minimum value of a distance from the optical axis to the non-arc portion is 21.5 mm. In a case where the noncircularity is defined as the ratio described above, it is 2.5/24=0.1. Thus, the noncircularity of the second lens is smaller than that of the first lens. In other words, the shape of the second lens is closer to a circle than that of the first lens.

Also in this example, as in Example 1, a refractive index of the second lens is larger than that of the first lens, so the birefringence of the second lens is larger than that of the first lens. More specifically, a photoelastic constant of the first lens is 7×10⁻¹² [1/Pa], and a photoelastic constant of the second lens is 45×10⁻¹² [1/Pa], and thus the photoelastic constant of the second lens is larger. In order to reduce the birefringence of the display optical system, the second lens, which is made of a resin material with a large birefringence, may have a shape with small noncircularity. Thus, the noncircularity of the second lens is smaller than that of the first lens.

In this way, the first lens and the second lens are noncircular lenses so that the HMD 301 does not interfere with the observer's nose or forehead, while minimizing birefringence that occurs during molding of each lens.

The noncircularity can also be defined as a ratio of a difference between the area of each of the first lens and the second lens and the area of the circle in which they are inscribed, to the area of the circle. In this case, the noncircularity of the first lens in this example is 0.06, and the noncircularity of the second lens is 0.02, which is smaller than the noncircularity of the first lens.

The noncircularity may also be defined as a ratio of the volume reduced from a circular lens (a lens whose entire outer circumference edge is inscribed in each of the circles) that is the base of the first lens and the second lens for the noncircular lens to the volume of the circular lens. In this example, the noncircularity of the first lens is 0.03, and the noncircularity of the second lens is 0.008, and the noncircularity of the second lens is smaller than that of the first lens.

In each of the above examples, the optical path of the display optical system is folded using two transmissive reflective surface, but the display optical system may also be one in which the optical path is folded using three or more transmissive reflective surface.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide a display optical system that suppresses birefringence and is less likely to cause interference with the observer's face.

This application claims the benefit of Japanese Patent Application No. 2024-130502, which was filed on Aug. 7, 2024, and which is hereby incorporated by reference herein in its entirety.

What is claimed is:

1. A display optical system configured to guide light from a display element to an observation side, the display optical system comprising:
a first lens;
a second lens adjacent to and disposed on a display element side of the first lens; and
at least two transmissive reflective surfaces,
wherein, when viewed from a direction in which an optical axis of the display optical system extends, each of the first lens and the second lens has a noncircular shape, and
wherein in a case where a degree of a difference between the noncircular shape and a circular shape is called noncircularity, noncircularity of the first lens and noncircularity of the second lens are different from each other.

2. The display optical system according to claim 1, wherein the noncircular shape of each of the first lens and the second lens is a noncircular shape in which a distance from the optical axis to a part of an outer circumference edge of each of the first lens and the second lens is shorter than a distance from the optical axis to another part of the outer circumference edge, and
wherein in a case where the noncircularity is defined as a ratio of a difference between a maximum value and a minimum value of the distance of each of the first lens and the second lens to the maximum value of the distance, the noncircularity of the second lens is smaller than the noncircularity of the first lens.

3. The display optical system according to claim 2, wherein the noncircularity of the first lens is 0.2 or more and 0.3 or less, and
wherein the noncircularity of the second lens is 0.1 or more and less than 0.2.

4. The display optical system according to claim 1, wherein the noncircular shape of each of the first lens and the second lens is a noncircular shape in which a part of an outer circumference edge of each of the first lens and the second lens closer to the optical axis than a circle in which each of the first lens and the second lens is inscribed, and
wherein the noncircularity is defined as a ratio of a difference between an area of each of the first lens and the second lens and an area of the circle to the area of the circle, the noncircularity of the second lens is smaller than the noncircularity of the first lens.

5. The display optical system according to claim 4, wherein the noncircularity of the first lens is 0.06 or more and 0.1 or less, and
wherein the noncircularity of the second lens is 0.01 or more and less than 0.06.

6. The display optical system according to claim 1, wherein each of the first lens and the second lens is a resin lens.

7. The display optical system according to claim 1, wherein the second lens has a refractive index higher than that of the first lens.

8. The display optical system according to claim 1, wherein the second lens has birefringence higher than that of the first lens.

9. The display optical system according to claim 8, wherein the first lens has a photoelastic constant of 10×10⁻¹² [1/Pa] or less, and
wherein the second lens has a photoelastic constant of 50× 10⁻¹² [1/Pa] or less.

10. The display optical system according to claim 1, wherein a part of an outer circumference edge has a shape closer to a straight line than to an arc shape.

11. The display optical system according to claim 1, wherein the first lens and the second lens are cemented together.

12. The display optical system according to claim 11, wherein in the first lens and the second lens that are cemented together, an outer shape of the second lens is larger than that of the first lens, and
wherein the second lens is held by a holding member.

13. The display optical system according to claim 1, wherein one of the at least two transmissive reflective surfaces is a polarization separation surface configured to reflect or transmit light according to a polarization state.

14. The display optical system according to claim 13, wherein the light from the display element transmits through the second lens, transmits through a half-mirror that forms one of the at least two transmissive reflective surfaces, transmits through the first lens, is reflected by the polarization separation surface, transmits through the first lens, is reflected by the half-mirror, transmits through the first lens, transmits through the polarization separation surface, and is guided to the observation side.

15. The display optical system according to claim 1, wherein the display optical system has a diagonal display angle of 60° or more, and
wherein a distance on the optical axis from a surface of the first lens disposed on the observation side of the first lens to a surface of the second lens disposed on the display element side of the second lens is 15 mm or less.

16. A display apparatus comprising:
a display element;
a display optical system configured to guide light from the display element to an observation side,
wherein the display optical system includes:
a first lens;
a second lens adjacent to and disposed on a display element side of the first lens; and
at least two transmissive reflective surfaces,
wherein, when viewed from a direction in which an optical axis of the display optical system extends, each of the first lens and the second lens has a noncircular shape,
wherein in a case where a degree of a difference between the noncircular shape and a circular shape is called noncircularity, noncircularity of the first lens and noncircularity of the second lens are different from each other, and
wherein the display apparatus is located in front of an observer's face.

17. The display apparatus according to claim 16, wherein a part of an outer circumference edge of each of the first lens and the second lens is located on at least one of a nose side and a forehead side of the observer.

18. The display apparatus according to claim 16, further comprising a camera disposed on a nose side of the observer and configured to image observer's eyes through the first lens and the second lens.
